(19) United States
(12) Patent Application Publication
(10) Pub. No.: US 2013/0070379 A1
(43) Pub. Date: Mar. 21, 2013

(54) POWER REGULATOR WITH OVER CURRENT PROTECTION AND CONTROL CIRCUIT THEREOF AND METHOD OF OVER CURRENT PROTECTION

(71) Applicants: Jiun-Hung Pan, Taipei City (TW); Chien-Fu Tang, Hsinchu City (TW); Isaac Y. Chen, Zhubei City (TW)

(72) Inventors: Jiun-Hung Pan, Taipei City (TW); Chien-Fu Tang, Hsinchu City (TW); Isaac Y. Chen, Zhubei City (TW)

(73) Assignee: Richtek Technology Corporation, R.O.C.

(21) Appl. No.: 13/239,362

(22) Filed: Sep. 21, 2011

(51) Int. Cl. H02H 3/093

(52) U.S. Cl. 361/87

(57) ABSTRACT

The present invention discloses a power regulator with over current protection (OCP), a control circuit thereof, and a method of over current protection. The power regulator with OCP includes: a primary circuit, a transformer, and a secondary circuit. The power regulator receives AC power, and generates secondary current which is supplied to a load circuit. The primary circuit includes a control circuit which includes: a switch control circuit, a first comparator circuit, a sample and hold circuit, and a compensation circuit which is coupled to the sample and hold circuit. The compensation circuit adaptively adjusts a threshold level of the OCP according to a current sense signal, or controls a delay time of an over current detection signal to compensate an error of the OCP threshold level, which is caused by the AC power, such that the primary current may have a peak corresponding to a predetermined setting.

### BACKGROUND OF THE INVENTION

1. Field of Invention

The present invention relates to a power regulator with over current protection (OCP), a control circuit thereof, and a method of over current protection; particularly, it relates to such power regulator, control circuit, and method wherein an OCP threshold setting or a delay time of an over current detection signal is adaptively adjusted according to a current sense signal, such that peak values of a primary current and a secondary current are kept consistent at different input voltages.

b 2. Description of Related Art

OCP is an essential protection in a power regulator. A straightforward approach is, as shown in FIG. 1A, comparing a current sense signal CS which relates to a primary current Ip of a transformer with an upper limit Vpeak by a comparator 11, and when the current sense signal CS exceeds the upper limit Vpeak, an over current detection signal OC is outputted to indicate occurrence of an over current event. A switch control circuit 12 which controls a power switch P according to a feedback signal (not shown) in normal operation turns OFF the power switch P according to the over current detection signal OC when the over current event occurs. This prior art needs to face the following problem: in an actual case, there is a period of delay time from when the comparator 11 outputs the over current detection signal OC to when the power switch P is turned OFF, and in this period of delay time, the primary current Ip and the current sense signal CS are still increasing. A solution to this problem is to set the upper limit Vpeak to a lower level, such that, even though the primary current Ip keeps increasing during the period of delay time, the primary current Ip will not be higher than an actually desired upper limit. However, this maneuver does not completely solve the problem. In different applications, the input voltage of the power regulator maybe different; for example, a high-line input voltage may be 375V while a low-line input voltage may be 127V, and the primary currents Ip in different conditions will increase at different rising speeds. Thus, at the time point when the power switch P is turned OFF, the values of the primary currents Ip in different conditions will be different, so are the output currents and powers. As a result, if the upper limit Vpeak is set to meet one of the conditions, the output power can not be regulated at a desired target in other conditions.

More specifically, FIG. 1B shows an ideal control of OCP. A thick solid line and a thin solid line respectively indicate signal waveforms of a primary current Ip_high and a primary current Ip_low corresponding to high-line and low-line input voltages. A dash line indicates a current limit Ipeak for the primary current, corresponding to the upper limit Vpeak. In the ideal condition without delay, no matter the input voltage is a high-line voltage or a low-line voltage, the peak value of the primary current (Ip_high or Ip_low) can be controlled at or below the current limit Ipeak exactly.

FIG. 1C shows the actual condition of the OCP control. In the actual condition, either the input voltage is the high line voltage or the low line voltage, there is a delay time Tp from when the primary current reaches the current limit Ipeak to when the power switch P is turned OFF. As shown in the figure, the peak value Ipeak1 of the high-line primary current Ip_high is higher than the peak value Ipeak2 of the low-line primary current Ip_low because of different rising speeds of the primary current. In consequence, this prior art cannot maintain the output power and the output current consistent for different input voltages.

In view of above, to overcome the drawbacks in the aforementioned prior art, U.S. Pat. No. 6,611,439 discloses a pulse width modulation (PWM) controller 50, which has the OCP control mechanism as shown in FIG. 2A. The OCP control mechanism of this prior art is different from the aforementioned prior art in that, a reference voltage Vinr related to the input voltage Vin is used to modify the over current detection signal. This prior art can adaptively adjust the OCP threshold setting according to whether the input voltage Vin is a high-line voltage or a low-line voltage, so that the output power or output current can be consistent. However, the controller 50 is usually integrated as an IC chip, and this prior art requires an additional pin to receive the signal Vinr as shown in FIG. 2A; thus, the cost of the IC chip is increased, and it narrows the application range of the IC chip. In FIG. 2A, Vcc is an internal voltage, and OSC is an oscillator circuit, which generates a clock signal to be inputted to a SQ flip-flop.

U.S. Pat. No. 7,215,105 discloses another power regulator, which has the OCP control mechanism as shown in FIGS. 2B-2C. The OCP mechanism of this prior art is different from the aforementioned prior art in that, during ON time of a PWM signal, a ramp signal Ramp is added to the original primary current limit Ipeak, such that the primary current limit Ipeak is increasing during the ON time as shown in FIG. 2C. Therefore, when the input voltage is a high-line voltage, the primary current will reach the current limit Ipeak earlier than the primary current does when the input voltage is a low-line voltage, such that the peak value of the primary current can be controlled in correspondence with the level of the input voltage, so as to improve the consistency of the output power or output current. However, because this prior art provides a fixed compensation rate (the rising speed of ramp signal Ramp is predetermined), this prior art has the drawback that the OCP control does not respond to differences in actual input voltages and therefore it cannot precisely adjust the peak value of the primary current. In FIG. 2B, LEB is a leading edge blanking circuit, and Source and Drain indicate a source and a drain of the power switch respectively.

In view of above, to overcome the drawbacks in the prior art circuits, the present invention proposes a power regulator with OCP, a control circuit thereof, and a method of OCP, wherein an OCP threshold setting is adaptively adjusted according to a current sense signal without requiring any additional pin of the IC chip, such that the IC chip has a lower cost and a wider application range.

### SUMMARY OF THE INVENTION

The first objective of the present invention is to provide a power regulator with OCP.

The second objective of the present invention is to provide a control circuit of a power regulator with OCP.

To achieve the objectives mentioned above, from one perspective, the present invention provides a power regulator with OCP including: a power conversion circuit, which includes at least one power switch, the power switch operating to convert an input voltage to an output voltage, wherein a current is generated; and a control circuit, which receives a current sense signal related to the current and generates an operation signal according to the current sense signal, the operation signal controlling the power switch to adjust the current, the control circuit including: a switch control circuit, which generates the operation signal according to a feedback signal and an over current detection signal; a first comparator, which compares the current sense signal with a threshold setting to generate a first comparator output signal for determining the over current detection signal; a sample and hold circuit, which outputs a peak signal indicating a peak value of the current sense signal according to the current sense signal; and a compensation circuit, which is coupled to the sample and hold circuit, the compensation circuit generating a compensation signal according to the peak signal and a predetermined setting, wherein the compensation signal determines the threshold setting, or controls a delay time of the first comparator output signal such that the delayed first comparator output signal becomes the over current detection signal; whereby the over current detection signal is adaptively adjusted according to the current such that the current has a peak value corresponding to the predetermined setting.

The aforementioned power conversion circuit for example includes a boost conversion circuit, a buck conversion circuit, a buck-boost conversion circuit, or a flyback conversion circuit.

From another perspective, the present invention provides a control circuit for use in a power regulator with over current protection (OCP), the power regulator including a power conversion circuit which includes at least one power switch, the power switch operating to convert an input voltage to an output voltage and a current being generated thereby; the control circuit including: a switch control circuit, which generates the operation signal according to a feedback signal and an over current detection signal; a first comparator, which compares the current sense signal with a threshold setting to generate a first comparator output signal for determining the over current detection signal; a sample and hold circuit, which outputs a peak signal indicating a peak value of the current sense signal according to the current sense signal; and a compensation circuit, which is coupled to the sample and hold circuit, the compensation circuit generating a compensation signal according to the peak signal and a predetermined setting, wherein the compensation signal determines the threshold setting, or controls a delay time of the first comparator output signal such that the delayed first comparator output signal becomes the over current detection signal, whereby the over current detection signal is adaptively adjusted according to the current such that the current has a peak value corresponding to the predetermined setting.

In one embodiment, the compensation signal is used to determine the threshold setting, and the compensation circuit preferably includes an error amplifier which generates the compensation signal according to the peak signal and the predetermined setting.

In another embodiment, the compensation circuit preferably includes: a second comparator, which compares the peak signal with the predetermined setting to generate the compensation signal; a counter, which generates a count signal according to the compensation signal; and a digital to analog converter (DAC) circuit, which converts the count signal to the threshold setting in analog form, to be inputted to the first comparator.

In yet another embodiment, the compensation circuit preferably includes: a delay circuit, which controls the delay time of the first comparator output signal according to a delay signal; and an error amplifier coupled to the sample and hold circuit, the error amplifier generating the compensation signal according to the peak signal and the predetermined setting; wherein the threshold setting is related to the predetermined setting and there is an offset between the threshold setting and the predetermined setting.

In yet another embodiment, the compensation circuit preferably includes: a delay circuit, which controls the delay time of the first comparator output signal according to a delay signal; a second comparator, which compares the peak signal with the predetermined setting to generate the compensation signal; a counter, which generates a count signal according to the compensation signal; and a DAC circuit, which converts the count signal to the delay signal in analog form, to be inputted to the delay circuit; wherein the threshold setting is related to the predetermined setting and there is an offset between the threshold setting and the predetermined setting.

From another perspective, the present invention provides a method of OCP which is used in a power regulator, the power regulator including at least one power switch, the power switch operating to generate an input current according to an input voltage, the input current being converted to an output current which is supplied to a load circuit; the method of OCP including: detecting the input current to generate a current sense signal; comparing the current sense signal with a threshold setting to generate a comparison signal for determining an over current detection signal, the over current detection signal being for turning OFF the power switch; generating a peak signal according to the current sense signal for indicating a peak value of the current sense signal; and generating a compensation signal according to the peak signal and a predetermined setting, wherein the compensation signal determines the threshold setting, or controls a delay time of the first comparator output signal such that the delayed comparison signal becomes the over current detection signal; whereby the over current detection signal is adaptively adjusted according to the input current such that the input current has a peak value corresponding to the predetermined setting.

In the aforementioned method of OCP, the step of generating the compensation signal preferably includes: comparing the peak signal with the predetermined setting to generate the compensation signal; generating a count signal according to the compensation signal; and converting the count signal to the threshold setting.

In another embodiment, the step of generating the compensation signal preferably includes: comparing the peak signal with the predetermined setting to generate the compensation signal; generating a delay signal according to the compensation signal; and delaying the comparison signal for the delay time according to the delay signal, such that the delayed comparison signal becomes the over current detection signal; wherein the threshold setting is related to the predetermined setting and there is an offset between the threshold setting and the predetermined setting.

In another embodiment, the step of generating the compensation signal preferably includes: comparing the peak signal with the predetermined setting to generate the compensation signal; generating a count signal according to the compensation signal; and delaying the comparison signal for the delay time according to the delay signal, such that the delayed comparison signal becomes the over current detection signal; wherein the threshold setting is related to the predetermined setting and there is an offset between the threshold setting and the predetermined setting.

The objectives, technical details, features, and effects of the present invention will be better understood with regard to the detailed description of the embodiments below.

### BRIEF DESCRIPTION OF THE DRAWINGS

FIGS. 1A-1C show a conventional OCP mechanism.

FIG. 2A shows a PWM controller which is disclosed in U.S. Pat. No. 6,611,439.

FIGS. 2B-2C show a power regulator which is disclosed in U.S. Pat. No. 7,215,105.

FIG. 3A shows a basic structure of the present invention.

FIGS. 3B-3H show various power conversion circuits 40 which may be used in the present invention.

FIGS. 4A-4C show a first embodiment of the present invention.

FIGS. 5A-5B show comparison of the signal waveforms of the primary current and the current sense signal when the input voltage is the high-line voltage or the low-line voltage in the prior art and the present invention.

FIGS. 6A-6B show a second embodiment of the present invention.

FIGS. 7A-7C show a third embodiment of the present invention.

FIG. 8 shows a fourth embodiment of the present invention.

### DESCRIPTION OF THE PREFERRED EMBODIMENTS

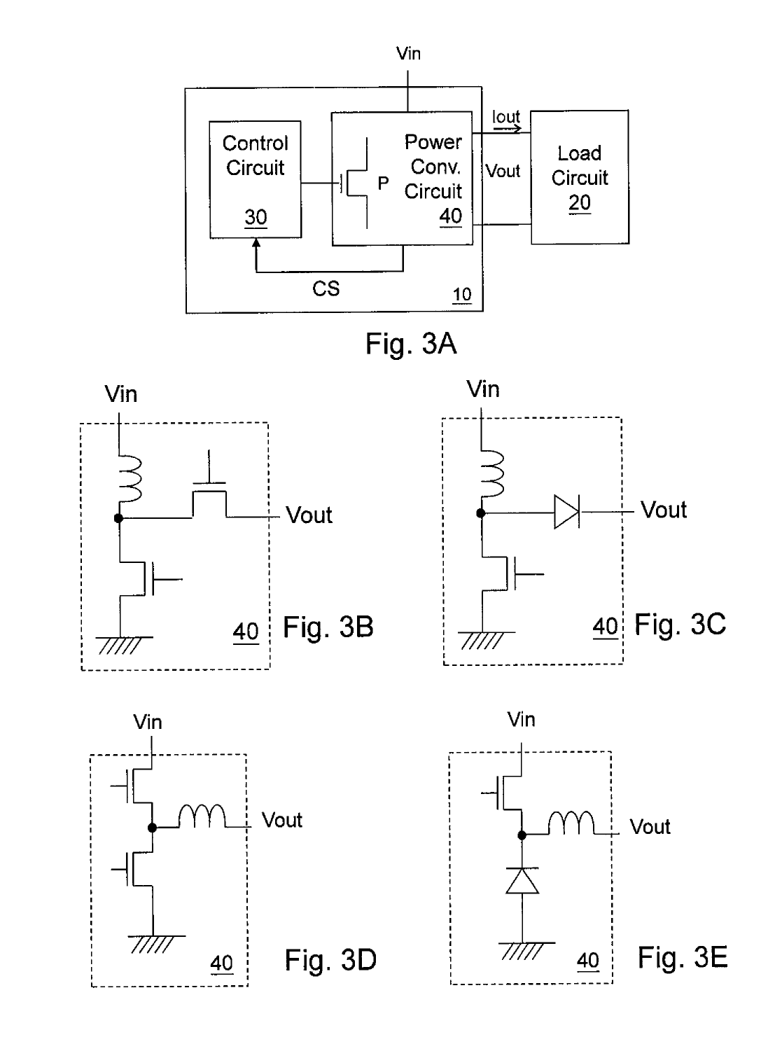

FIG. 3A shows a basic structure of the present invention. A power regulator 10 includes a control circuit 30 and a power conversion circuit 40. The control circuit 30 controls at least one power switch P to convert the input voltage yin to the output voltage Vout, and to provide an output current lout to a load circuit 20, wherein the control circuit 30 receives the current sense signal CS and performs OCP control according to the current sense signal CS. The power conversion circuit 40 is for example but not limited to boost conversion circuits as shown in FIGS. 3B-3C, buck conversion circuits as shown in FIGS. 3D-3E, buck-boost conversion circuits as shown in FIGS. 3F-3G, or a flyback conversion circuit as shown in FIG. 3H. In the following context, the present invention will be described with reference to the flyback conversion circuit as an example, but the present invention is not limited to the flyback conversion circuit; the present invention can be applied to any type of power conversion circuit, as long as it requires OCP control and the input voltage may vary so that the delay time from when an over current event is detected to when the power switch is actually turned OFF may cause inconsistency of output power or output current.

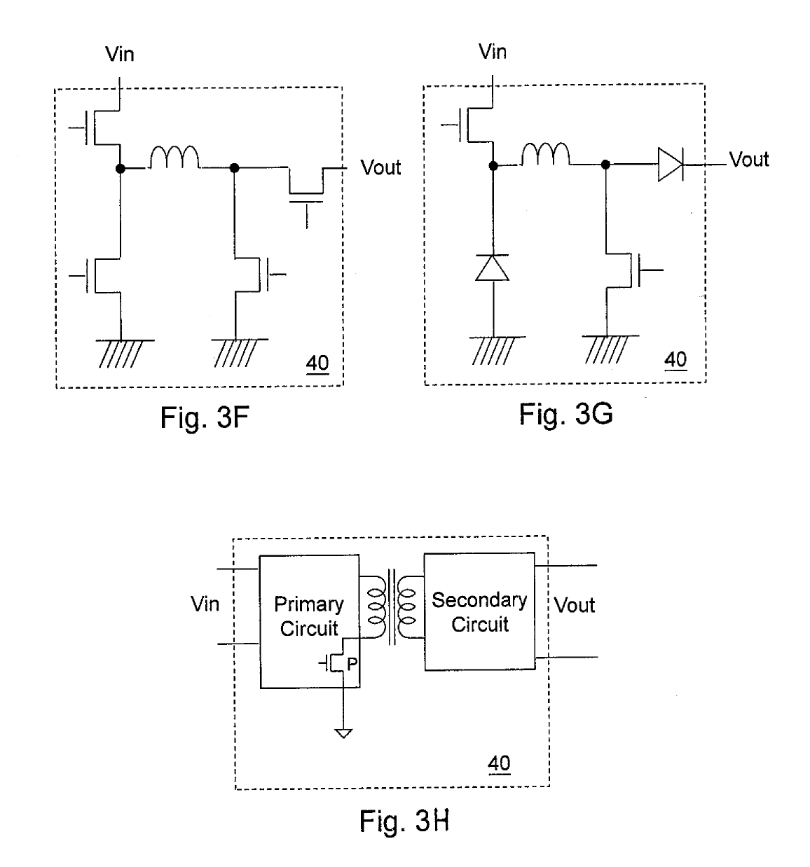

Please refer to FIGS. 4A-4C for a first embodiment of the present invention. FIG. 4A shows the power conversion circuit 40 of the power regulator 10. The power conversion circuit 40 is a flyback conversion circuit, which includes a primary circuit 13, a transformer 15 coupled to the primary circuit 13, and a secondary circuit 17 coupled to the transformer 15. The primary circuit 13 receives the rectified AC input voltage Vin and generates the primary current Ip, and a current sense signal CS is generated according to the primary current Ip. The transformer 15 converts the primary current Ip to a secondary current. The secondary circuit 17 receives the secondary current and generates the output current lout which is supplied the load circuit 20. The control circuit 30 controls the power switch P of the primary circuit 13 according to a feedback signal FB, which is generated for example by detecting the output current lout or the output voltage Vout. As shown in FIG. 4B, the control circuit 30 includes a switch control circuit 12, a comparator 31, a sample and hold circuit 32, and an error amplifier 33 coupled to the sample and hold circuit 32. The comparator 31 compares the current sense signal CS related to the primary current Ip with a threshold setting to generate the over current detection signal OC. The switch control circuit 12 controls the power switch P according to the feedback signal (not shown in FIG. 4B), and turns OFF the power switch P according to the over current detection signal OC, to regulate the primary current Ip. The sample and hold circuit 32 outputs a peak signal according to the current sense signal CS, which indicates the peak value of the current sense signal CS. The error amplifier 33 generates a compensation signal according to the peak signal and a predetermined setting, and the threshold setting is generated according to the compensation signal; hence, the threshold setting is adaptively adjusted to a proper value according to a difference between the peak signal and the predetermined setting. In this embodiment, the threshold setting is the compensation signal itself, but the present invention is not limited to this embodiment. For example, an offset voltage (not shown) may be added between the output of the error amplifier 33 and the input of the comparator 31. Other variations are also possible, and some examples will be described later.

FIG. 4C shows signal waveforms of the current sense signal CS, the predetermined setting, and the threshold setting; the waveforms show that the threshold setting is adaptively adjusted according to the current sense signal CS. As shown in the figure, if the predetermined setting is set to a target of the current sense signal CS, which is Vpeak, the control circuit 30 will adaptively adjust the threshold setting such that the peak value of the current sense signal CS is controlled at the predetermined setting, that is, the primary current Ip will be adaptively adjusted such that its peak value will be controlled at a desired target (Ipeak, corresponding to the target Vpeak of the current sense signal CS) regardless how the input voltage changes. Therefore, the consistency of the output power or output current is improved.

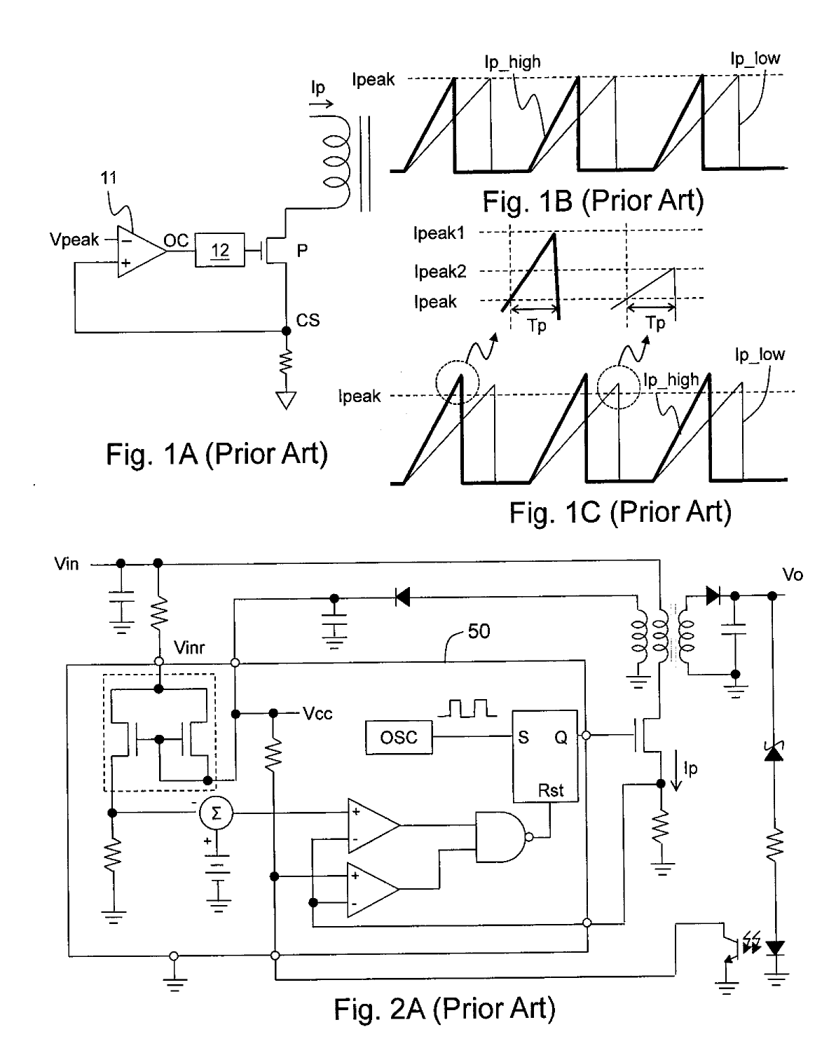

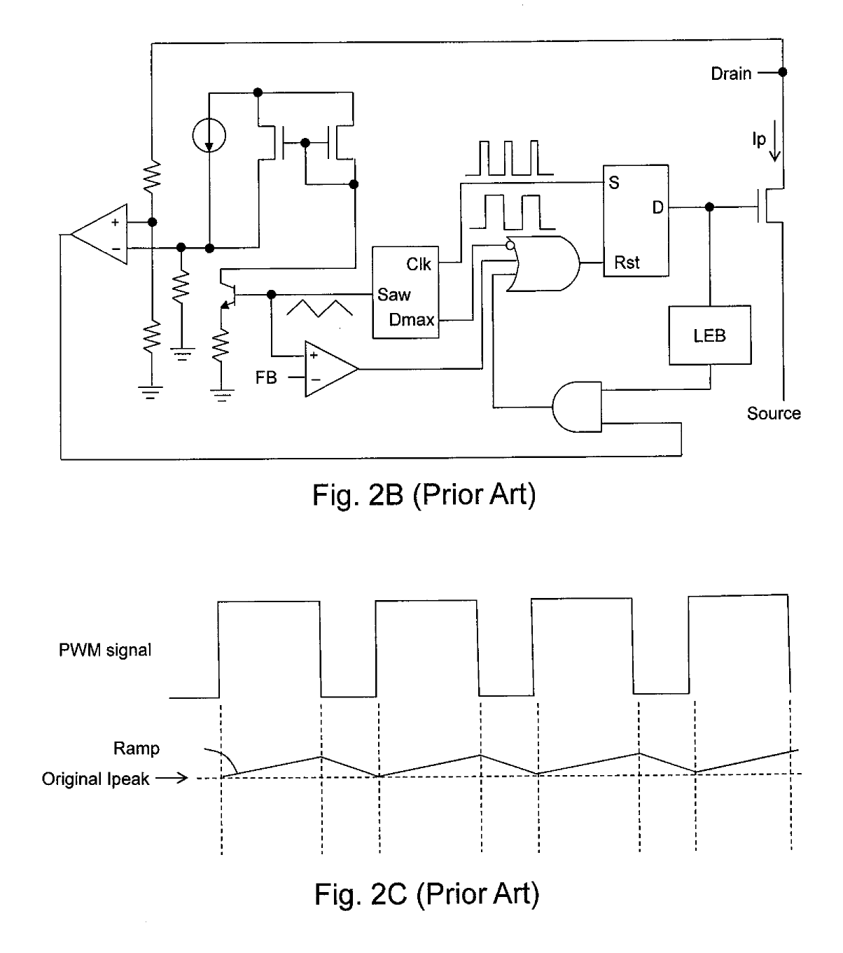

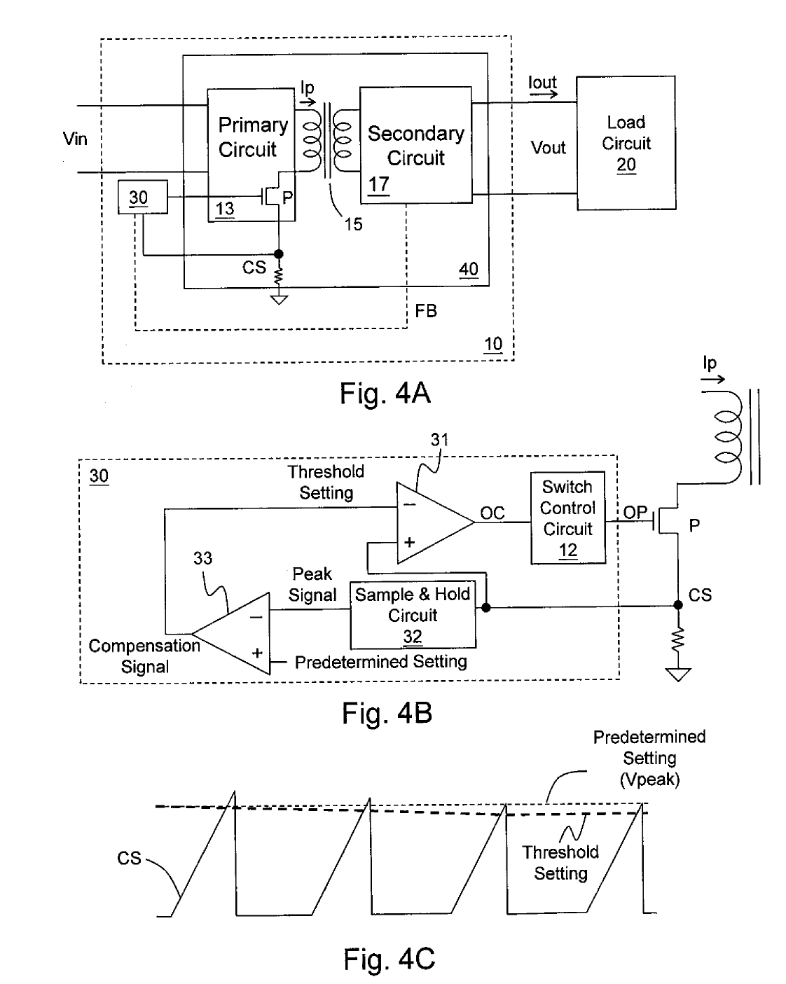

FIGS. 5A and 5B show signal waveforms of the primary currents (Ip_high and Ip_low) and current sense signals (CS_high and CS_low) corresponding to high-line and low-line input voltages, in the prior art shown in FIGS. 1A-1C and in the embodiment of the present invention shown in FIGS. 4A-4C respectively. Referring to FIG. 5A, as described in the description of related art, during the same delay time Tp, the peak value of the actual primary current Ip_high (corresponding to high-line input voltage) is higher than the peak value of the primary current Ip_low (corresponding to low-line input voltage); correspondingly, the peak value of the current sense signal CS_high is also higher than the current sense signal CS_low. Even though the primary current limit Ipeak and the current sense signal upper limit Vpeak are constant settings, the peak values of the primary current and the current sense signal will change when the input voltage Vin changes, so the peak values of the output power and output current can not be kept consistent.

In contrast, as shown in FIG. 5B, the upper limit Vpeak (which is the predetermined setting inputted to a positive input terminal of the error amplifier 33 in FIG. 4B) set for the current sense signals CS_high and CS_low is adaptively adjusted to Vpeak 1 or Vpeak2 (which is the threshold setting inputted to a negative input terminal of the comparator 31 in FIG. 4B) in correspondence to high-line or low-line input voltage. Even though the input voltages are different, the peak value of the primary current Ip_high and Ip_Low is the same, which is the desired current limit Ipeak, such that the present invention improves the consistency of the output power and the output current.

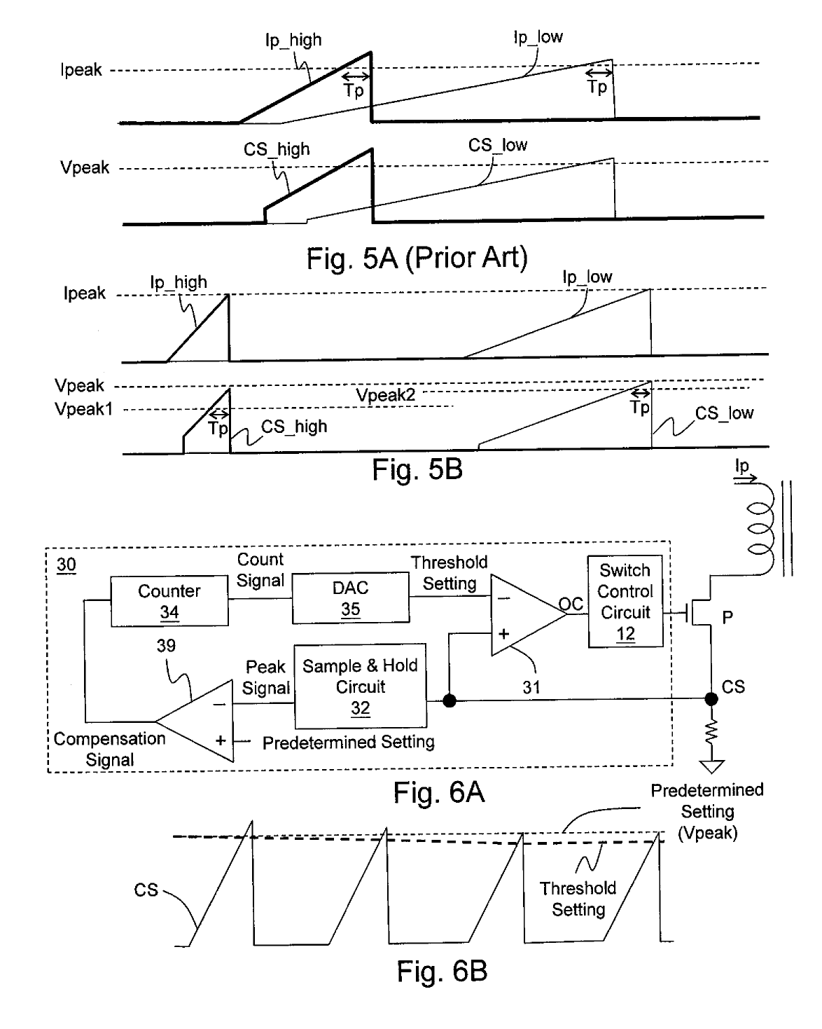

FIGS. 6A and 6B show a second embodiment of the present invention. This embodiment is different from the first embodiment in that the compensation signal is generated and processed in digital form. As shown in FIG. 6A, besides the switch control circuit 12, the comparator 31 and the sample and hold circuit 32, the control circuit 30 further includes a comparator 39 coupled to the sample and hold circuit 32, a counter 34, and a digital to analog converter (DAC) 35. The comparator 39 compares the peak signal with the predetermined setting to generate the compensation signal. The counter 34 receives the compensation signal and counts up or down according to the compensation signal to generate a count signal. The DAC 35 converts the count signal to the threshold setting. FIG. 6B shows signal waveforms of the current sense signal CS, the upper limit (Vpeak) of the current sense signal (which is the predetermined setting), and the threshold setting. The waveforms show that the threshold setting is adaptively adjusted according to the current sense signal CS. This embodiment achieves a similar result to the first embodiment.

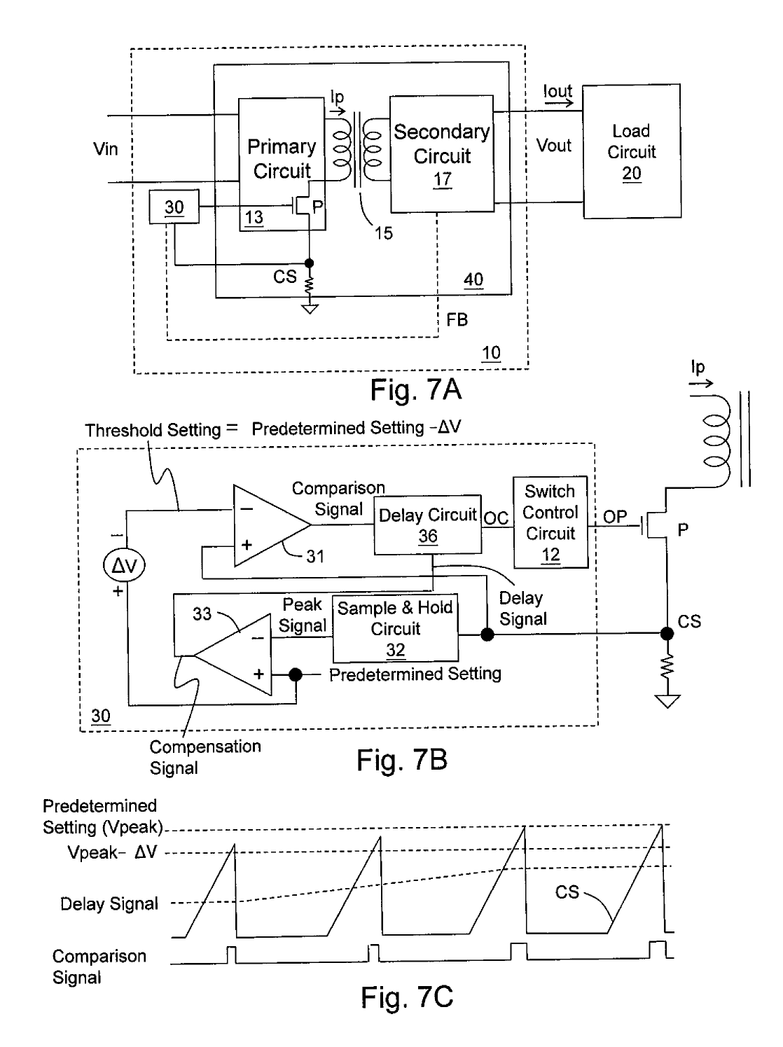

FIGS. 7A-7C show a third embodiment of the present invention. The circuit shown in FIG. 7A is similar to that shown in FIG. 4A, wherein the power conversion circuit 40 of the power regulator 10 is the flyback circuit, which includes a primary circuit 13, a transformer 15 coupled to the primary circuit 13, and a secondary circuit 17 coupled to the transformer 15. The primary circuit 13 receives the rectified AC input voltage Vin and generates the primary current Ip, and a current sense signal CS is generated according to the primary current Ip. The transformer 15 converts the primary current Ip to the secondary current. The secondary circuit 17 receives the secondary current and generates the output current lout which is supplied to the load circuit 20. The control circuit 30 controls the power switch P of the primary circuit 13 according to a feedback signal FB, which is generated for example by detecting the output current lout or the output voltage Vout. As shown in FIG. 7B, the control circuit 30 includes the comparator 31, the sample and hold circuit 32, the error amplifier 33 coupled to the sample and hold circuit 32, a delay circuit 36, and the switch control circuit 12. The comparator 31 compares the current sense signal CS which is related to the primary current Ip with the threshold setting to generate a comparison signal. In this embodiment, the threshold setting is preferably lower than the predetermined setting, expressed by (predetermined setting-ΔV) in the figure. However, please note that the bias device ΔV is shown in the figure for illustration of the voltage difference between the threshold setting and the predetermined setting, but it does not mean that a bias device ΔV must be provided in the circuit for the bias voltage −ΔV. As an equivalent, a reference signal which is equal to (predetermined setting-ΔV) can be inputted to the comparator 31. The sample and hold circuit 32 generates the peak signal according to the current sense signal CS, indicating the peak value of the current sense signal CS. The error amplifier 33 compares the peak signal with the predetermined setting to generate the compensation signal. A delay signal is generated according to the compensation signal, which is used to control the delay time of the delay circuit 36. In this embodiment, the delay signal is the compensation signal, but the present invention is not limited to this. For example, the compensation signal outputted from the error amplifier 33 may be converted to a digital signal, and the delay circuit 36 may be controlled by a digital way. The delay circuit 36 receives the delay signal and the comparison signal and outputs the over current detection signal OC. The switch control circuit 12 generates an operation signal OP according to the over current detection signal OC, so as to operate the power switch P to adjust the primary current Ip.

FIG. 7C shows waveforms of related signals to explain how the third embodiment achieves the purpose of providing consistent output power and output current. This embodiment is different from the aforementioned embodiments in that it adaptively controls the delay time. In the prior art of FIG. 1A, the delay time from when the comparator 11 outputs the over current detection signal OC to when the power switch P is turned OFF is different in high-line and low-line conditions, and the different delay time causes the output power and output current inconsistency. This embodiment solves this inconsistency by adaptively controlling the delay time. For example, for low-line input voltage, the delay time is extended; for high-line input voltage, the delay time is not extended, or less extended. As shown in FIGS. 7B and 7C, the peak value of the current sense signal CS is compared with the predetermined setting to generate the compensation signal. The compensation signal is inputted to the delay circuit 36 to control the delay time, such that the delay time is longer when the input voltage is lower, and the delay time is shorter when the input voltage is higher. Because of the feedback balance mechanism of the loop, the peak value of the primary current Ip can be controlled at the primary current limit Ipeak (corresponding to the upper limit Vpeak, i.e., the predetermined setting), such that the consistency of the output power and the output current can be improved.

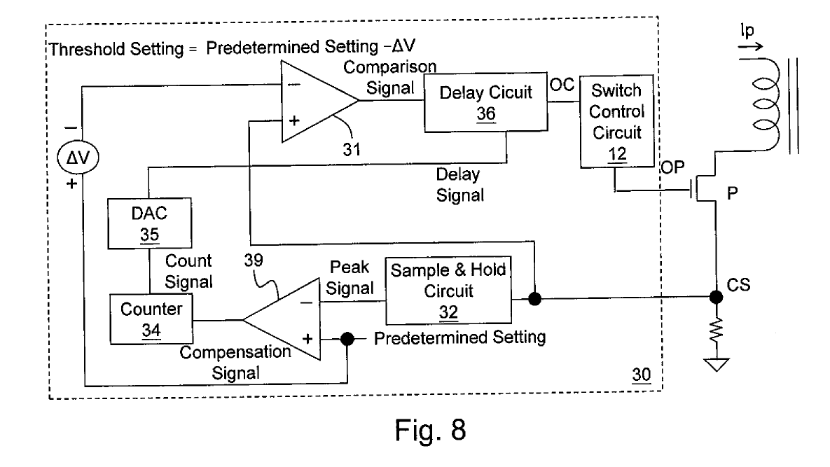

FIG. 8 shows a fourth embodiment of the present invention. This embodiment is different from the third embodiment in that the compensation signal is generated and processed in digital form. As shown in FIG. 8, besides the switch control circuit 12, the comparator 31, the sample and hold circuit 32 and the delay circuit 36, the control circuit 30 includes a comparator 39 coupled to the sample and hold circuit 32, a counter 34, and a DAC circuit 35. The comparator 39 compares the peak signal with the predetermined setting to generate the compensation signal. The counter 34 receives the compensation signal and counts up or down according to the compensation signal to generate the count signal. The DAC circuit 35 converts the count signal to the delay signal. This embodiment is similar to the third embodiment and both embodiments achieve similar results. Note that if the delay circuit 36 is controlled by a digital way, the DAC circuit can be omitted. A delay circuit with a delay time controllable by a digital or analog way is well known by those skilled in the art, so details thereof are omitted here.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch or the like. For another example, the positive and negative input terminals of the error amplifiers or comparators are interchangeable, with corresponding amendment of the circuits processing these signals. For example, if the positive and negative input terminals of the comparators 31 shown in FIG. 7B and 8 are interchanged, the threshold setting is preferably changed to (predetermined setting+ΔV). In view of the foregoing, the spirit of the present invention should cover all such and other modifications and variations, which should be interpreted to fall within the scope of the following claims and their equivalents.

What is claimed is:

1. A power regulator with over current protection (OCP) comprising:
a power conversion circuit, which includes at least one power switch, the power switch operating to convert an input voltage to an output voltage, wherein a current is generated; and
a control circuit, which receives a current sense signal related to the current and generates an operation signal according to the current sense signal, the operation signal controlling the power switch to adjust the current, the control circuit including:
a switch control circuit, which generates the operation signal according to a feedback signal and an over current detection signal;
a first comparator, which compares the current sense signal with a threshold setting to generate a first comparator output signal for determining the over current detection signal;
a sample and hold circuit, which outputs a peak signal indicating a peak value of the current sense signal according to the current sense signal; and
a compensation circuit, which is coupled to the sample and hold circuit, the compensation circuit generating a compensation signal according to the peak signal and a predetermined setting, wherein the compensation signal determines the threshold setting, or controls a delay time of the first comparator output signal such that the delayed first comparator output signal becomes the over current detection signal;
whereby the over current detection signal is adaptively adjusted according to the current such that the current has a peak value corresponding to the predetermined setting.

2. The power regulator of claim 1, wherein the compensation signal determines the threshold setting, and the compensation circuit includes an error amplifier which generates the compensation signal according to the peak signal and the predetermined setting.

3. The power regulator of claim 1, wherein the compensation circuit includes:
a second comparator, which compares the peak signal with the predetermined setting to generate the compensation signal;
a counter, which generates a count signal according to the compensation signal; and
a digital to analog converter (DAC) circuit, which converts the count signal to the threshold setting in analog form, to be inputted to the first comparator.

4. The power regulator of claim 1, wherein the compensation circuit includes:
a delay circuit, which controls the delay time of the first comparator output signal according to a delay signal related to the compensation signal; and
an error amplifier coupled to the sample and hold circuit, the error amplifier generating the compensation signal according to the peak signal and the predetermined setting;
wherein the threshold setting is related to the predetermined setting and there is an offset between the threshold setting and the predetermined setting.

5. The power regulator of claim 1, wherein the compensation circuit includes:
a delay circuit, which controls the delay time of the first comparator output signal according to a delay signal;
a second comparator, which compares the peak signal with the predetermined setting to generate the compensation signal;
a counter, which generates a count signal according to the compensation signal; and
a DAC circuit, which converts the count signal to the delay signal in analog form, to be inputted to the delay circuit;
wherein the threshold setting is related to the predetermined setting and there is an offset between the threshold setting and the predetermined setting.

6. The power regulator of claim 1, wherein the power conversion circuit includes a boost conversion circuit, a buck conversion circuit, a buck-boost conversion circuit, or a flyback conversion circuit.

7. The power regulator of claim 1, wherein the power conversion circuit includes a primary circuit, a transformer coupled to the primary circuit, and a secondary circuit coupled to the transformer, wherein the current sense signal is related to a current generated by the primary circuit.

8. A control circuit for use in a power regulator with over current protection (OCP), the power regulator including a power conversion circuit which includes at least one power switch, the power switch operating to convert an input voltage to an output voltage and a current being generated thereby; the control circuit comprising:
a switch control circuit, which generates the operation signal according to a feedback signal and an over current detection signal;
a first comparator, which compares the current sense signal with a threshold setting to generate a first comparator output signal for determining the over current detection signal;
a sample and hold circuit, which outputs a peak signal indicating a peak value of the current sense signal according to the current sense signal; and
a compensation circuit, which is coupled to the sample and hold circuit, the compensation circuit generating a compensation signal according to the peak signal and a predetermined setting, wherein the compensation signal determines the threshold setting, or controls a delay time of the first comparator output signal such that the delayed first comparator output signal becomes the over current detection signal,
whereby the over current detection signal is adaptively adjusted according to the current such that the current has a peak value corresponding to the predetermined setting.

9. The control circuit of claim 8, wherein the compensation signal determines the threshold setting, and the compensation circuit includes an error amplifier which generates the compensation signal according to the peak signal and the predetermined setting.

10. The control circuit of claim 8, wherein the compensation circuit includes:
a second comparator, which compares the peak signal with the predetermined setting to generate the compensation signal;
a counter, which generates a count signal according to the compensation signal; and
a digital to analog converter (DAC) circuit, which converts the count signal to the threshold setting in analog form, to be inputted to the first comparator.

11. The control circuit of claim 8, wherein the compensation circuit includes:
a delay circuit, which controls the delay time of the first comparator output signal according to a delay signal; and
an error amplifier coupled to the sample and hold circuit, the error amplifier generating the compensation signal according to the peak signal and the predetermined setting;
wherein the threshold setting is related to the predetermined setting and there is an offset between the threshold setting and the predetermined setting.

12. The control circuit of claim 8, wherein the compensation circuit includes:
a delay circuit, which controls the delay time of the first comparator output signal according to a delay signal;
a second comparator, which compares the peak signal with the predetermined setting to generate the compensation signal;
a counter, which generates a count signal according to the compensation signal; and
a DAC circuit, which converts the count signal to the delay signal in analog form, to be inputted to the delay circuit;
wherein the threshold setting is related to the predetermined setting and there is an offset between the threshold setting and the predetermined setting.

13. A method of over current protection (OCP) for use in a power regulator, the power regulator including at least one power switch, the power switch operating to generate an input current according to an input voltage, the input current being converted to an output current which is supplied to a load circuit; the method of OCP comprising:
detecting the input current to generate a current sense signal;
comparing the current sense signal with a threshold setting to generate a comparison signal for determining an over current detection signal, the over current detection signal being for turning OFF the power switch;
generating a peak signal according to the current sense signal for indicating a peak value of the current sense signal; and
generating a compensation signal according to the peak signal and a predetermined setting, wherein the compensation signal determines the threshold setting, or controls a delay time of the first comparator output signal such that the delayed comparison signal becomes the over current detection signal;
whereby the over current detection signal is adaptively adjusted according to the input current such that the input current has a peak value corresponding to the predetermined setting.

14. The method of OCP of claim 13, wherein the step of generating the compensation signal comprises:
comparing the peak signal with the predetermined setting to generate the compensation signal;
generating a count signal according to the compensation signal; and
converting the count signal to the threshold setting.

15. The method of OCP of claim 13, wherein the step of generating the compensation signal comprises:
comparing the peak signal with the predetermined setting to generate the compensation signal;
generating a delay signal according to the compensation signal; and
delaying the comparison signal for the delay time according to the delay signal, such that the delayed comparison signal becomes the over current detection signal;
wherein the threshold setting is related to the predetermined setting and there is an offset between the threshold setting and the predetermined setting.

16. The method of OCP of claim 13, wherein the step of generating the compensation signal comprises:
comparing the peak signal with the predetermined setting to generate the compensation signal;
generating a count signal according to the compensation signal; and
delaying the comparison signal for the delay time, such that the delayed comparison signal becomes the over current detection signal;
wherein the threshold setting is related to the predetermined setting and there is an offset between the threshold setting and the predetermined setting.
